(19) United States
(12) Patent Application Publication
(10) Pub. No.: US 2024/0003923 A1
(43) Pub. Date: Jan. 4, 2024

(54) CALIBRATION AND VALIDATION OF CUVETTES IN AUTOMATED CHEMICAL ANALYZERS

(71) Applicant: Beckman Coulter, Inc., Brea, CA (US)

(72) Inventors: Kana KAMI, Shizuoka (JP); Noriyoshi OKADA, Shizuoka (JP); Noriyuki ITO, Shizuoka (JP); Takayuki MIZUTANI, Chaska, MN (US)

(21) Appl. No.: 18/254,630

(22) PCT Filed: Nov. 29, 2021
(86) PCT No.: PCT/US2021/060930

§ 371 Date: May 26, 2023

Related U.S. Application Data
(60) Provisional application No. 63/131,241, filed on Dec. 28, 2020.

(51) Int. Cl. G01N 35/00; G01N 21/90; G01N 35/02

(52) U.S. Cl. CPC G01N 35/00613; G01N 35/00693; G01N 21/90; G01N 35/0092; G01N 35/025

(57) ABSTRACT

The presently claimed and described technology provides improved calibration and validation procedures for sample containers (e.g., cuvettes) in automated chemical analyzers. The claimed and described technology further provides methods of operating an automated analyzer that allows for the automation of calibrating and tracking the integrity of individual sample containers (e.g., cuvettes) in parallel with measuring constituent samples. These methods eliminate the need to alternate between a diagnostic mode and measurement mode when performing system maintenance, such as validating cuvette integrity, calibrating absorbance baseline, and replacing cuvettes. As such, the presently claimed and described technology can reduce downtime and improve the clinical lab productivity significantly by allowing for this system maintenance to occur simultaneously with sample analysis.

### RELATED APPLICATIONS

The present patent application claims the priority benefit of U.S. Provisional Patent Application Ser. No. 63/131,241, filed Dec. 28, 2020, the content of which is hereby incorporated by reference in its entirety into this disclosure.

### FIELD

Various aspects of the presently disclosed and claimed technology relate to calibration and validation of cuvettes in automated chemical analyzers, and specifically to improved methods to assess the integrity of cuvettes utilized in such analyzers.

### BACKGROUND

Automated chemical analyzers are commonly used in clinical chemistry sampling and analyzing applications. Automated analytical equipment, such as automated analytical chemistry workstations, can efficiently perform clinical analysis on a large number of samples, with tests being run concurrently or within short time intervals. Efficiencies result, in part, because of the use of automated sample identification and tracking. This equipment can automatically prepare appropriate volume samples and can automatically set the test conditions needed to perform the scheduled tests. Test conditions can be independently established and tracked for different testing protocols simultaneously in progress within a single test station, facilitating the simultaneous execution of a number of different tests based on different chemistries and requiring different reaction conditions. Automated analytical equipment is particularly well-suited for high volume testing environments, such as those existing in many hospitals and in centralized testing laboratories, because the automatic sample handling allows for more precise sample identification and sample tracking. Automatic handling and tracking of samples significantly reduce the opportunity for human error or accidents that can lead to either erroneous test results or undesirable contamination.

Calibration and validation of sample containers (e.g., cuvettes) is an important part of using an automated chemical analyzer to assure data accuracy. Tracking the integrity of individual sample containers is needed but can be very time-consuming. Thus, current calibration and validation procedures limit their use in on-going assessments, e.g., they may not be done with sufficient frequency. This can lead to data inaccuracies, inefficiencies, and increased costs.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

The inventors have recognized the need for improved calibration and validation procedures for sample containers (e.g., cuvettes) in automated chemical analyzers. In particular, a method that allows automation of calibrating and tracking the integrity of individual sample containers (e.g., cuvettes) is disclosed.

One aspect of the presently disclosed and claimed technology is a method of operating an automated analyzer, the method comprising the steps of: providing the automated analyzer, the automated analyzer comprising: one or more cuvettes; a plurality of positions, the plurality of positions comprising: at least one reagent dispensing position; at least one constituent dispensing position; at least one cuvette washing position; and at least one constituent measurement position; at least one cuvette transporter with a plurality of cuvette holders; at least one photometer; and a controller; and moving the one or more cuvettes between the plurality of positions with the at least one cuvette transporter according to a schedule of the controller; measuring at least some cuvettes of the one or more cuvettes with the at least one photometer when each of the at least some cuvettes is at the at least one constituent measurement position according to the schedule of the controller and thereby determining at least one characteristic of each of the at least some cuvettes; assigning each of the cuvettes measured at the at least one constituent measurement position a disabled status if the at least one characteristic of the cuvette is higher than a first pre-determined threshold; and dispensing a constituent into a corresponding cuvette of the one or more cuvettes when the corresponding cuvette is at one of the dispensing positions, if a constituent test is scheduled for the corresponding cuvette at the at least one constituent measurement position according to the schedule of the controller, unless the corresponding cuvette is assigned the disabled status.

In a further aspect of the present technology, the method further comprises the step of measuring the constituent in the corresponding cuvette with the photometer when the corresponding cuvette is at the at least one constituent measurement position if the constituent was dispensed into the corresponding cuvette and if the constituent test was scheduled for the corresponding cuvette at the at least one constituent measurement position.

In another aspect of the present technology, the method further comprises the step of rescheduling the constituent test if the corresponding cuvette is assigned the disabled status. In a further aspect, the rescheduling occurs in response to an earlier known disabled status. In yet another aspect, the rescheduling step occurs in response to a just-assigned disabled status. In a yet further aspect, the rescheduling step results in a substitution of a non-tested constituent. In an additional aspect, the non-tested constituent comprises a portion of a dilution. Alternatively, the non-tested constituent comprises a portion of a pre-treatment.

In at least one aspect of the present technology, the constituent is a biological sample. In another aspect, the biological sample is selected from the group consisting of blood, plasma, serum, saliva, urine, cerebrospinal fluid, lacrimal fluid, perspiration, gastrointestinal fluid, amniotic fluid, mucosal fluid, pleural fluid, and sebaceous oil. In yet another aspect, the biological sample can be from a mammal, preferably a human. In a further aspect, the biological sample is test-ready.

In at least one additional aspect of the present technology, before the constituent is measured with the photometer, the cuvette with the constituent is moved to the at least one reagent dispensing position, and a reagent is dispensed. In another aspect, the measuring of the at least some cuvettes of the one or more cuvettes with the photometer includes measuring absorbance for each of the cuvettes of at least one pre-determined wavelength of electromagnetic radiation. In a further aspect, measuring absorbance for each of the cuvettes for the at least one pre-determined wavelength of electromagnetic radiation generates a plurality of absorbance data points for each of the cuvettes at each of the at least one pre-determined wavelength of electromagnetic radiation, alternatively for at least thirteen pre-determined wavelengths of electromagnetic radiation.

In at least one further aspect of the present technology, the measuring of the at least some cuvettes of the one or more cuvettes with the photometer includes measuring absorbance for each of the cuvettes at thirteen different pre-determined wavelengths of electromagnetic radiation. In a further aspect, the thirteen different pre-determined wavelengths of electromagnetic radiation comprise a short wavelength limit, a long wavelength limit, and eleven different wavelengths between the short wavelength limit and the long wavelength limit. In yet a still further aspect, at least one of the pre-determined wavelengths of electromagnetic radiation is a UV wavelength or a visible wavelength. In yet another aspect, the short wavelength limit is a UV wavelength, and the long wavelength limit is a visible wavelength.

In another aspect of the present technology, the at least one characteristic of each of the at least some cuvettes includes at least absorbance variance. Additionally, in another aspect, the absorbance variance is a difference between a maximum absorbance and a minimum absorbance measured for at least one pre-determined wavelength of electromagnetic radiation. In still further aspect, each of the cuvettes measured at the constituent measurement position is assigned an enabled status if the at least one characteristic of the cuvette is within a pre-determined range or less than a second pre-determined threshold.

In at least one aspect of the present technology, the method further comprises the step of applying at least one enhanced cleaning routine when a cuvette assigned the disabled status is at the at least one cuvette washing position. In another aspect, the at least one enhanced cleaning routine includes dispensing detergent to the cuvette assigned the disabled status. In yet another aspect, after applying the at least one enhanced cleaning routine, the method comprises the step of further measuring the cuvette assigned the disabled status with the photometer, when the cuvette is at the constituent measurement position and reassigning a disabled status if the at least one characteristic of the cuvette is higher than the first pre-determined threshold or assigning an enabled status if the at least one characteristic of the cuvette is less than the second pre-determined threshold or within a pre-determined range. In yet another aspect, if the cuvette is reassigned the disabled status, a subsequent enhanced cleaning routine is applied when the cuvette with the reassigned disabled status is at the at least one cuvette washing position. In a further aspect, the subsequent enhanced cleaning routine is applied for a pre-determined number of applications before the cuvette is assigned a retirement status. In yet another aspect, the pre-determined number of applications is at least ten applications.

In one further aspect of the present technology, the method further comprises the step of notifying an operator of a need to replace at least one cuvette assigned the disabled status. In another aspect, the method further comprises notifying the operator of the number of cuvettes assigned the disabled status. In yet another aspect, the method further comprises the step of notifying the operator of the reduced capacity of the automated analyzer due to the disabled status of at least one of the cuvettes. In a further aspect, the method comprises the step of notifying the operator of a location on the cuvette transporter of each of the cuvettes to be replaced via a display screen.

In one aspect of the present technology, the automated analyzer is an automated clinical chemistry analyzer. In another aspect, the one or more cuvettes includes reusable cuvettes or disposable cuvettes. In a further aspect, the one or more cuvettes are made from glass, plastic, or optical-grade quartz.

In one further aspect of the present technology, the at least one photometer includes a light source, which can, for example, be a halogen lamp. In another aspect, the method further comprises the step of monitoring the deterioration of the light source. In yet a further aspect, the method further comprises the step of modeling the deterioration of the light source with statistical analysis to forecast a replacement time.

In another aspect of the present technology, at least some cuvettes of the one or more cuvettes contain a liquid when the at least one characteristic of the cuvette is determined. In another aspect, at least some cuvettes of the one or more cuvettes do not contain liquid when the at least one characteristic of the cuvette is determined. In a further aspect, the method further comprises the step of performing statistical analysis on the at least one characteristic of the cuvette. In yet a further aspect, the statistical analysis produces values distinguishing an imperfection type. In yet another aspect, the imperfection type includes, for example, scratches and stains. In another aspect, after determining the at least one characteristic of at least one cuvette that does not contain liquid, the cuvette is then filled with a liquid, and at least one characteristic of the cuvette filled with a liquid is determined. In one aspect, the liquid is de-ionized water. In a further aspect, the cuvette transporter includes a wheel with the plurality of cuvette holders. In another aspect, the method further comprises repeatedly operating corresponding components at a plurality of positions on a cycle of the wheel. In yet further aspect, the cuvette transporter moves the one or more cuvettes between the plurality of positions at a fixed sequence. In yet another aspect, the fixed sequence corresponds with five cycles of the components at the plurality of positions. In a further aspect, each of the one or more cuvettes is positioned once at the at least one constituent measurement position every five cycles.

These and other advantages, aspects, and novel features of the present disclosure, as well as details of an illustrated embodiment thereof, will be more fully understood from the following description and drawings.

### BRIEF DESCRIPTION OF THE FIGURES

Embodiments of the present disclosure will now be described, by way of example only, with reference to the attached Figures, wherein:

FIGS. 1A and 1B are configuration diagrams for explaining a schematic configuration of an automated analyzer, in accordance with example embodiments of the disclosure.

FIG. 2 shows several versions of a cuvette wheel that may be used as a part of an automated analyzer, in accordance with an example embodiment of the disclosure.

FIGS. 3A and 3B show illustrations of photometers that may be used as a part of an automated analyzer, in accordance with an example embodiment of the disclosure.

FIG. 4 shows a cuvette transporter having a plurality of cuvette holders traveling to a constituent measurement position, in accordance with an example embodiment of the disclosure.

FIG. 5 illustrates routine calibration and validation analysis of a cuvette utilizing sixteen data points, in accordance with an example embodiment of the disclosure.

FIGS. 6A-6D depict portions of a cycle of a cuvette wheel, in accordance with an example embodiment of the disclosure. FIGS. 6A, 6B, and 6C illustrate example embodiments of a washing cycle, and FIG. 6D illustrates an example embodiment of a dispensing, mixing, and washing cycles.

FIG. 7 is a flowchart depicting the basic determination of enabled and disabled cuvettes, in accordance with an example embodiment of the disclosure.

FIG. 8 is a flowchart depicting the determination of enabled and disabled cuvettes using a diagnostic and a measurement mode, in accordance with an example embodiment of the disclosure.

FIG. 9 shows maximum and minimum data for one hundred seventy-nine cuvettes, at one wavelength in accordance with an example embodiment of the disclosure.

FIG. 10 shows a characterization of results of data point groups, in accordance with an example embodiment of the disclosure.

FIG. 11 shows a range of baseline absorbance between two different methods, in accordance with an example embodiment of the disclosure.

FIG. 12 shows the mean±3SD of baseline absorbance between two different methods, in accordance with an example embodiment of the disclosure.

FIG. 13A illustrates a cuvette position in a cuvette wheel and each function layout in accordance with an example embodiment of the disclosure.

FIG. 13B illustrates a profile of a photometer in accordance with an example embodiment of the disclosure where real-time calibration and validation occurs.

FIG. 14 illustrates a controller that may be used as part of the automated analyzer, in accordance with an example embodiment of the disclosure.

### DETAILED DESCRIPTION

Various embodiments will be described in detail with reference to the drawings, wherein like reference numerals represent like parts and assemblies throughout the several views. It is to be understood that this disclosure is not limited to the particular methodology, protocols, and reagents described herein and as such may vary. It is also to be understood that the terminology used herein is for the purpose of describing particular embodiments only and is not intended to limit the scope of the present disclosure or the appended claims.

As used herein and in the appended claims, the singular forms “a,” “an,” and “the” include plural reference unless the context clearly indicates otherwise.

Unless defined otherwise, all technical and scientific terms used herein have the same meaning as commonly understood to one of ordinary skill in the art to which this disclosure belongs.

As described herein, improved calibration and validation procedures for sample containers in automated chemical analyzers are disclosed. When using sample containers in automated analyzers, the variability of measurement in each sample container needs to be calibrated for data accuracy. Also, sample containers can degrade or become damaged over time, which leads to biased results. Therefore, sample container integrity also needs to be validated in advance of using the containers for subsequent analysis. Utilizing these procedures, sample containers (e.g. cuvettes) can be analyzed to determine if they should be enabled or disabled for use in sample analysis.

Quantitation of routine chemistry analytes is typically based on one of two measurements: (1) Measurement of light (photometry or spectrophotometry); or (2) Measurement of electrochemical potential (potentiometry). While the examples below discuss photometry (the measurement of absorbance), other methods of analysis, such as potentiometry, may be utilized.

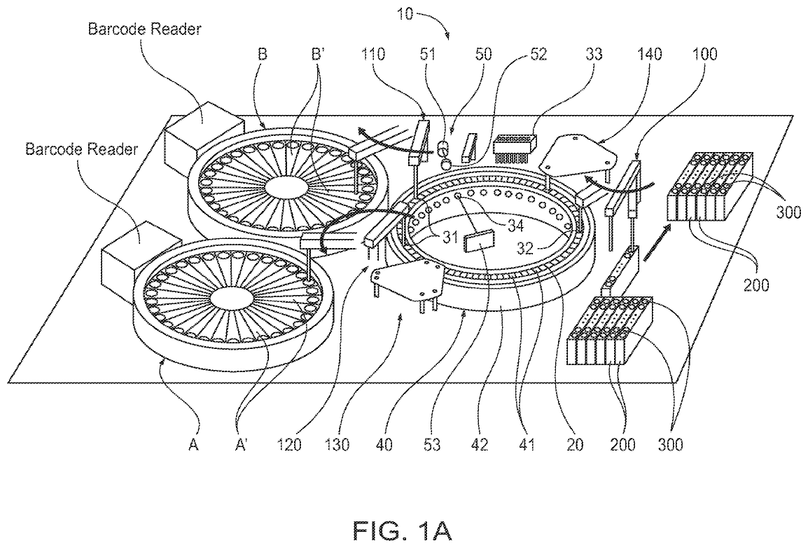

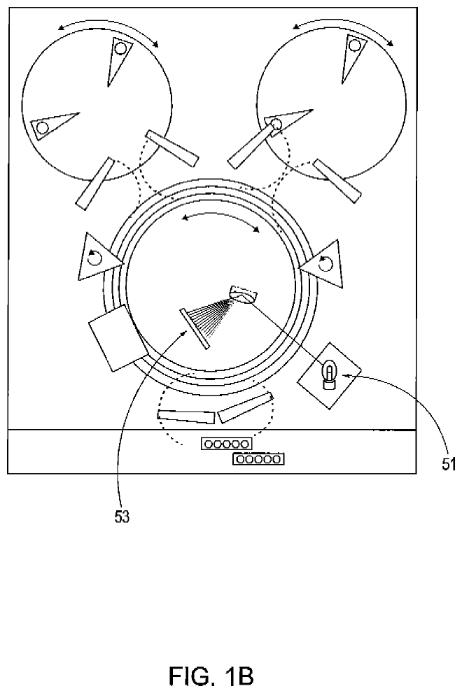

A configuration of an automatic analyzer according to at least one embodiment of the presently described and claimed technology is described below with reference to FIGS. 1A, 1B, 2, 3, and 4. FIGS. 1A and 1B are configuration diagrams for explaining a schematic configuration of an automated analyzer 10 according to an embodiment of the present described and claimed technology.

In the specific embodiments provided below, the sample containers in the automated analyzer are cuvettes 20, and the method allows for efficient calibration and validation of each cuvette, in addition to measurement of constituents after validation of the cuvette. The automated analyzer 10 comprises at least a cuvette transporter 40 and photometer 50, which are described in detail below. Specific embodiments of operating an automated analyzer 10 to calibrate and/or validate the integrity of cuvettes are also described.

The automated analyzer 10 can be an automated clinical chemistry analyzer. Clinical chemistry analyzers are medical laboratory devices used to calculate the concentration of certain substances within samples of serum, plasma, urine and/or other body fluids. Substances analyzed through these instruments include, for example, certain metabolites, electrolytes, proteins, and/or drugs.

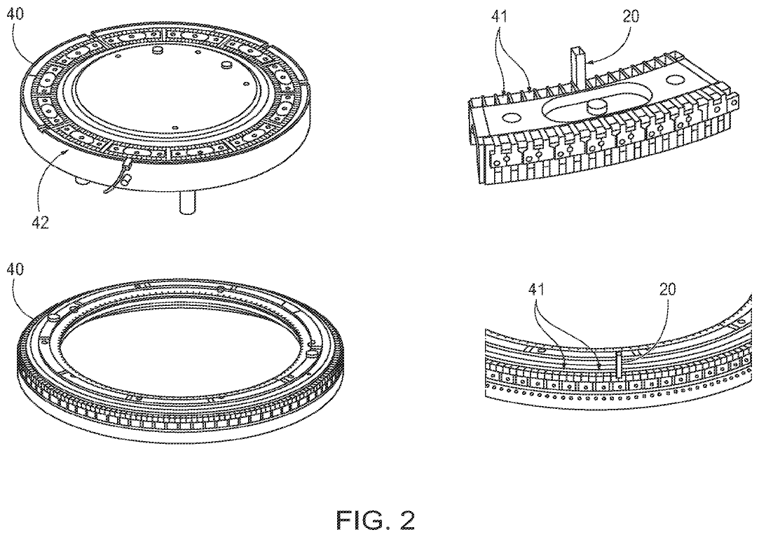

As shown in FIGS. 1A, 1B, and 2, the automated analyzer 10 comprises at least one cuvette transporter 40 with a plurality of cuvette holders 41, wherein the plurality of cuvette holders 41 may hold one or more cuvettes 20. The one or more cuvettes 20 may be reusable cuvettes. Glass, plastic, and quartz, among others, are suitable for cuvette materials. In a non-limiting example, at least one cuvette of the one or more cuvettes 20 may be made from, for example, glass, plastic, or optical-grade quartz.

The cuvette transporter 40 further includes a wheel 42 that allows for the plurality of cuvette holders 41 to travel through a plurality of positions on the automated analyzer 10. In an embodiment of the present technology, the plurality of positions includes dispensing positions, including, but are not limited to, at least one reagent dispensing position 31, at least one constituent dispensing position 32, and at least one cuvette washing position 33. The plurality of positions also includes at least one constituent measurement position 34. FIG. 2 shows several versions of a wheel 42, specifically a cuvette wheel, that may be used as a part of an automated analyzer 10. At least some of the cuvettes in the cuvette holders 41 may be deemed a corresponding cuvette. “Corresponding cuvette” is a cuvette that is arranged to receive a constituent, reagent, water, and/or detergent when said cuvette is at a dispense position.

The automated analyzer 10 may include various units for the processing of constituents. As illustrated in FIG. 1A, in some embodiments of the presently claimed technology, the automated analyzer 10 comprises a constituent dispensing unit 100 for dispensing, e.g., biological samples for analysis, a first reagent dispensing unit 110, a second reagent dispensing unit 120, a first stirring unit 130, and a second stirring unit 140. The first reagent dispensing unit 110 may have a reagent A (in reagent bottles A′), while a second reagent dispensing unit 120 may have a reagent B (in reagent bottles B′), where the reagents may be chemicals needed for reaction with the constituent sample before performing a constituent test or may be materials such as solvents, calibrators, standards or controls. Barcode readers may be used to identify reagents during an automated process. Stirring units provide physical mixing within the sample containers (e.g., cuvettes). It would be appreciated by those of skill in the art that multiple combinations of a number of reagents are envisaged in the understanding and practice of the presently claimed technology.

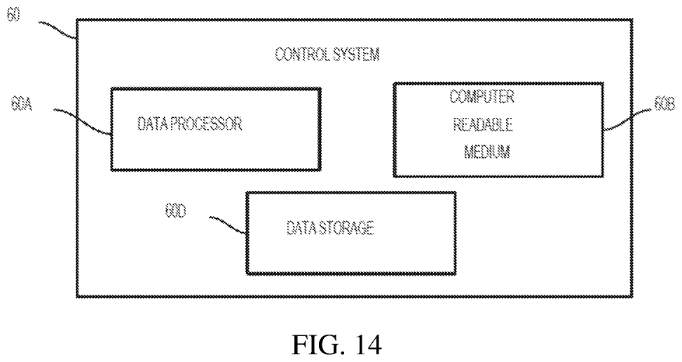

At operation, the one or more cuvettes 20 is moved between the plurality of positions with the at least one cuvette transporter 40 according to a schedule of a controller 60. All of the units of the automated analyzer 10 are connected to the controller, which can perform block control of all of the analyzer functions by using, for example, a microcomputer. The controller may contain subunits such as a data processing unit, a communication interface, and others. A controller 60 in accordance with an exemplary embodiment of the present technology is illustrated in FIG. 14. In this embodiment, the controller 60 may comprise a data processor 60A, a non-transitory computer-readable medium 60B, and a data storage 60C coupled to the data processor 60A. The non-transitory computer-readable medium 60B may comprise code, executable by the data processor to perform the functions described herein. The data processor 60A may store, for example, data for processing samples, sample data, or data for analyzing sample data.

The data processor 60A may include any suitable data computation device or combination of such devices. An exemplary data processor may comprise one or more microprocessors working together to accomplish a desired function. The data processor 60A may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; Apple M1, and/or the like processor(s).

The computer-readable medium 60B and the data storage 60C may be any suitable device or devices that can store electronic data. Examples of memories may comprise, for example, one or more memory chips, disk drives, etc. Such memories may operate using any suitable electrical, optical, and/or magnetic mode of operation.

The computer-readable medium 60B may comprise code, executable by the data processor 60A to perform any suitable method. For example, the computer-readable medium 60B may comprise code, executable by the processor 60A, to cause the controller 60 to operate on a pre-determined schedule. In some embodiments of the presently claimed technology, the pre-determined schedule is a constituent test. In other embodiments, the computer-readable medium 60B may comprise code, executable by the data processor 60A, to cause the controller 60 to reschedule a constituent test if the corresponding cuvette is assigned the disabled status.

To validate integrity of at least some of the one or more cuvettes 20, at least some of the cuvettes are moved to the constituent measurement position 24 according to the schedule of the controller. When the one or more cuvettes 20 is at the at least one constituent measurement position 24, at least one characteristic of each of the one or more cuvettes 20 is determined using the at least one photometer 50. The characteristic of the cuvette corresponds to a measurement of the cuvette in the absence of a sample. In some embodiments, the characteristic is, for example, the absorbance of the cuvette measured at one or more wavelengths.

The automated analyzer 10 is configured to allow for cell blanking. Cell blanking is the baseline measurement of cuvettes. The measured absorbance is used to subtract background during the determination of at least one characteristic of each of the one or more cuvettes 20 and/or measuring the constituent in a corresponding cuvette with the photometer 50 when the cuvette is at the at least one constituent measurement position 34.

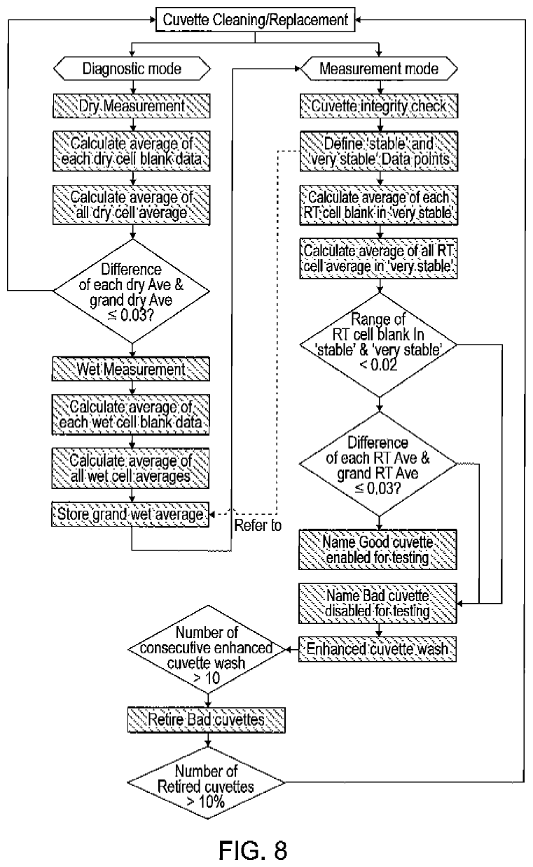

In some embodiments of the presently claimed technology, the automated analyzer 10 is configured to allow for dry cell blanking. In an embodiment, multiple absorbance data points per cuvette without liquid are measured over multiple wavelengths of electromagnetic radiation. In an exemplary embodiment, sixteen (16) data points are measured for thirteen (13) pre-determined wavelengths of electromagnetic radiation. The measured absorbance data points are averaged for each pre-determined wavelength of electromagnetic radiation, and an average dry cell blank average across all cuvettes (i.e., a grand dry average) is obtained for each pre-determined wavelength of electromagnetic radiation. In an embodiment, the dry cell blanking further comprises performing a statistical analysis on the at least one characteristic of the cuvette. The statistical analysis can produce a value distinguishing damage such as an imperfection type. In some embodiments, the imperfection type includes, for example, scratches, stains, and/or cracks. See FIG. 8.

In some embodiments of the presently claimed technology, the automated analyzer 10 is configured to allow for wet cell blanking. In an embodiment, multiple absorbance data points per cuvette with liquid, such as de-ionized water, are measured over multiple wavelengths. In an exemplary embodiment, sixteen (16) data points are measured for thirteen (13) pre-determined wavelengths of electromagnetic radiation. The measured absorbance data points are averaged for each pre-determined wavelength of electromagnetic radiation, and an average dry cell blank average across all cuvettes (i.e., a grand wet average) is obtained for each pre-determined wavelengths of electromagnetic radiation. See FIG. 8.

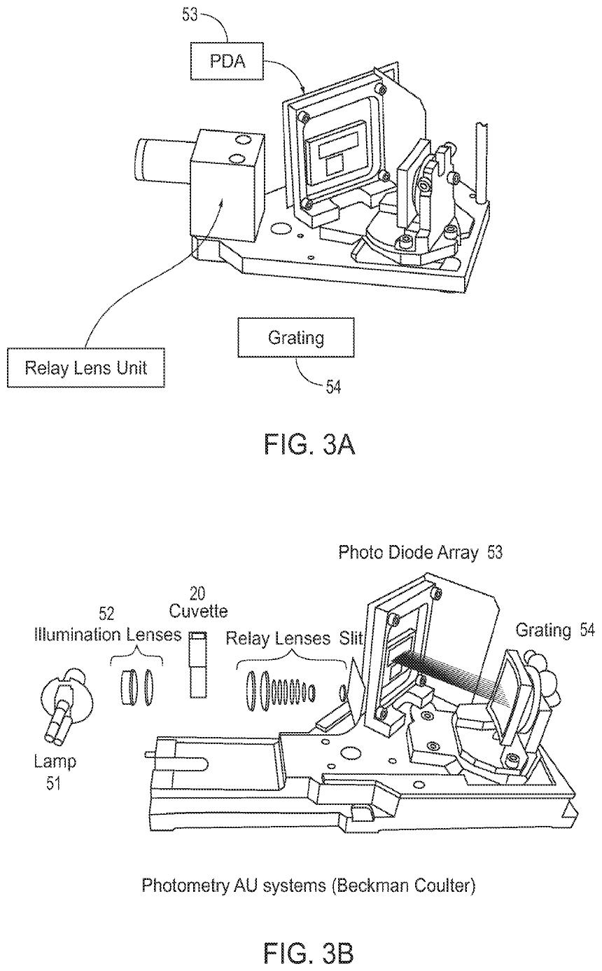

Photometry measures the concentration of various analytes by measuring the absorbance of light, as optical density. A monochromator or filter is used to select the desired wavelength of light for each analysis, depending on the properties of the substance being measured. Diffraction gratings may be used to separate the light wavelengths and enables monochromatic measurements, which is required in the automated analyzer. The individual wavelengths are measured by individual detectors in a photodiode array. As shown in FIGS. 3A and 3B, the photometer 50 focuses light (using a lens 52) of the appropriate wavelength on the one or more cuvettes 20 when the cuvette is at the constituent measurement position 34. In some embodiments, the photometer 50 comprises a light source 51, such as a halogen lamp. Other suitable alternatives include, for example, a tungsten lamp, quartz lamp, or a similar light source. When the light source 51 is a halogen lamp, it can generate a usable wavelength range of about 330 nm to about 3500 nm. Light from the light source 51 is passed through the constituent in the one or more cuvettes 20. In an embodiment, the automated analyzer 10 is configured to allow for monitoring the deterioration of the light source. In an embodiment, the monitoring further comprises modeling the deterioration of the light source with statistical analysis to forecast a replacement time.

When the light passes through the cuvette, various frequencies of the light are absorbed at various levels of absorbance, depending on the interaction of the light with the cuvette and the liquid therein. Upon passing through the cuvette, the various frequencies of the light are spatially separated (e.g., by a prism or a diffraction grating). Separating the frequencies by diffraction grating (vs. a prism) results in little or no interference. In some aspects, the light from a multi-frequency halogen source is focused on the cuvette using a diffraction grating 54.

A photodetector 53 measures the optical density, or the amount of light that is absorbed, by the constituent. In some embodiments of the presently claimed technology, the photodetector comprises a photodiode array. The photodiode array measures the intensity of specified wavelength, and therefore several photodiode arrays would be needed to measure the intensity of a number of wavelengths. For example, if thirteen (13) wavelengths are measured, then the photodiode array has thirteen (13) photodiodes.

When the photometer 50 is measuring the cuvette at the constituent measurement position 34, the amount of light absorbed, and the frequency of light may be correlated to the concentration of the analyte in the sample. In some embodiments, the measuring of at least some cuvettes 21 at the constituent measurement position 34 includes, for example, measuring absorbance data for each of the cuvettes for at least one pre-determined wavelength of electromagnetic radiation. In alternative aspects, the absorbance for each of the cuvettes is measured for at least two (2) pre-determined wavelengths of electromagnetic radiation, alternatively for at least three (3) pre-determined wavelengths of electromagnetic radiation, alternatively for at least four (4) pre-determined wavelengths of electromagnetic radiation, alternatively for at least five (5) pre-determined wavelengths of electromagnetic radiation, alternatively for at least six (6) pre-determined wavelengths of electromagnetic radiation, alternatively for at least seven (7) pre-determined wavelengths of electromagnetic radiation, alternatively for at least eight (8) pre-determined wavelengths of electromagnetic radiation, alternatively for at least nine (9) pre-determined wavelengths of electromagnetic radiation, alternatively for at least ten (10) pre-determined wavelengths of electromagnetic radiation, alternatively for at least eleven (11) pre-determined wavelengths of electromagnetic radiation, alternatively for at least twelve (12) pre-determined wavelengths of electromagnetic radiation, alternatively for at least thirteen (13) pre-determined wavelengths of electromagnetic radiation.

In some embodiments of the present technology, the photometer is configured to transmit and measure differing wavelengths. In at least one embodiment, at least two (2) wavelengths are transmitted by the photometer, with the higher wavelength being the long wavelength limit and the lower wavelength being the short wavelength limit. The photodetector further comprises single detectors in correspondence with each wavelength transmitted by the photometer.

In some embodiments of the present technology, both the long wavelength limit and the short wavelength limit are wavelengths in the visible spectrum. In other aspects, the long wavelength limit is in the visible spectrum, and the short wavelength limit is in the UV spectrum. For example, in one aspect, the short wavelength limit may be about 340 nm and the long wavelength limit may be about 800 nm. However, short wavelength limits may be as low as about 330 nm, alternatively about 320 nm, alternatively about 310 nm, or alternatively about 300 nm. The long wavelength limit may be as high as about 825 nm, alternatively about 850 nm, alternatively about 875 nm, or alternatively about 900 nm.

In some embodiments, the photometer is configured to perform a wavelength scan that allows for the simultaneous detection of absorbance data at several wavelengths within the range of the short wavelength limit and the long wavelength limit. In at least some embodiments, the absorbance data for each of the cuvettes is measured for at least three (3) wavelengths of electromagnetic radiation— the short wavelength limit, the long wavelength limit, and a wavelength in between the two. In an embodiment, thirteen (13) different pre-determined wavelengths of electromagnetic radiation are measured. In this embodiment, the thirteen (13) different pre-determined wavelengths of electromagnetic radiation comprise a short wavelength limit, a long wavelength limit, and eleven (11) different wavelengths between the short wavelength limit and the long wavelength limit. In such an embodiment, the short wavelength limit is about 340 nm, the long wavelength limit is about 800 nm, and the eleven (11) different wavelengths are within the range of about 340 nm to about 800 nm. In this embodiment, the pre-determined wavelengths of electromagnetic radiation include 340 nm, 380 nm, 410 nm, 450 nm, 520 nm, 540 nm, 570 nm, 600 nm, 660 nm, 700 nm, 750 nm, and 800 nm.

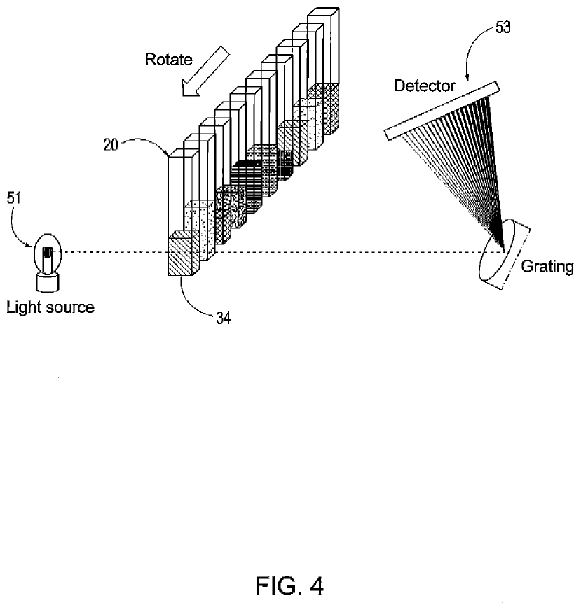

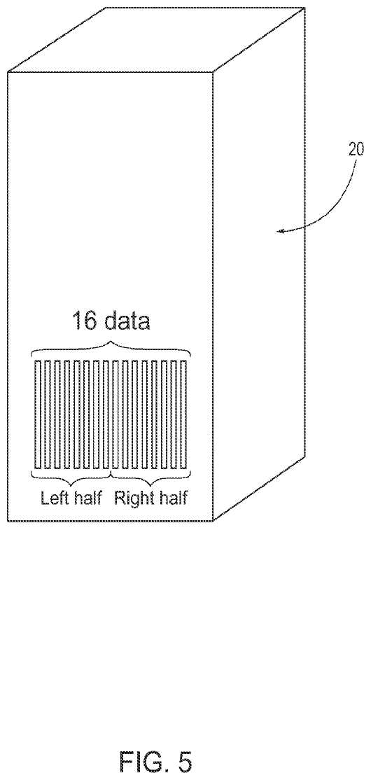

In an embodiment for validating the integrity of the cuvettes measured at the at least one constituent measurement position 34, the cuvette is disabled if the at least one characteristic of the cuvette is higher than a first pre-determined threshold, or alternatively, enabled if the at least one characteristic of the cuvette is lower than a second pre-determined threshold. In an embodiment, the at least one characteristic of each of the one or more cuvettes 20 includes absorbance variance. To measure absorbance variance, as shown in FIG. 4, the cuvette transporter 40 having the plurality of cuvette holders 41 travels to the at least one constituent measurement position 34. The absorbance of the one or more cuvettes 20 is measured at multiple wavelengths, utilizing a light source 51 and a photodetector 53 to determine the at least one characteristic.

In an exemplary embodiment, the absorbance for each of the cuvettes is measured for at least thirteen (13) pre-determined wavelengths of electromagnetic radiation. In this embodiment, the measuring of absorbance data of the cuvettes for at least pre-determined wavelength of electromagnetic radiation generates fifty-six (56) absorbance data points for each cuvette at each pre-determined wavelength of electromagnetic radiation. An exemplary automated analyzer 10 includes a wheel 42 with over two hundred (200) cuvette holders and a forty-one slot pitch shift per cycle. The wheel 42 spins past forty-one (41) cuvette holders in 0.893 seconds, and the cycle time is 3.6 seconds. The cuvette rotates at a decelerating speed, with a cycle angle of 72.35 degrees. After five cycles, the cuvette shifts +1 slot pitch in position on the wheel (41×5=205=204+1), and in 12.3 minutes, a cuvette returns to its original position. Each cycle, for example, has an acceleration portion, a constant velocity portion, a deceleration portion, and a rest portion.

In routine calibration and validation analyses, sixteen (16) data points of absorbance data are obtained for each cuvette in a separate system cycle, and an average is used to determine baseline and correct for the variability of cuvettes. This same data can be used to compare the right half (8 data points) and left half (8 data points) of a cuvette to assess if the cuvette has any damage such as scratches or imperfections. See FIG. 5. This procedure is time-consuming and inefficient as it requires the automated analyzer 10 to be switched from measurement mode to diagnostic mode for the calibration and validation analyses.

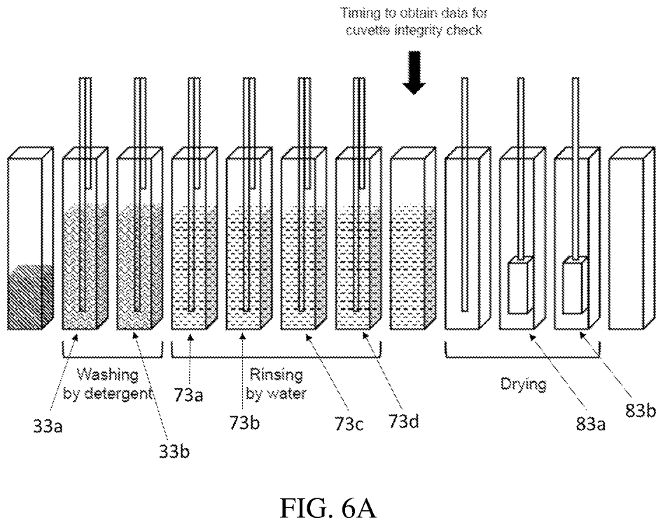

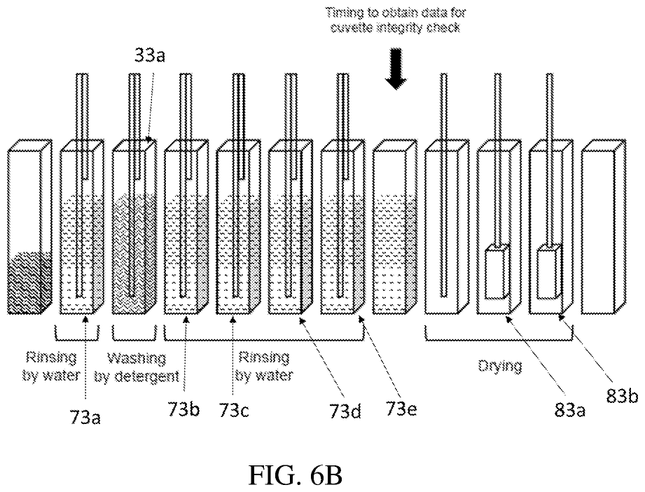

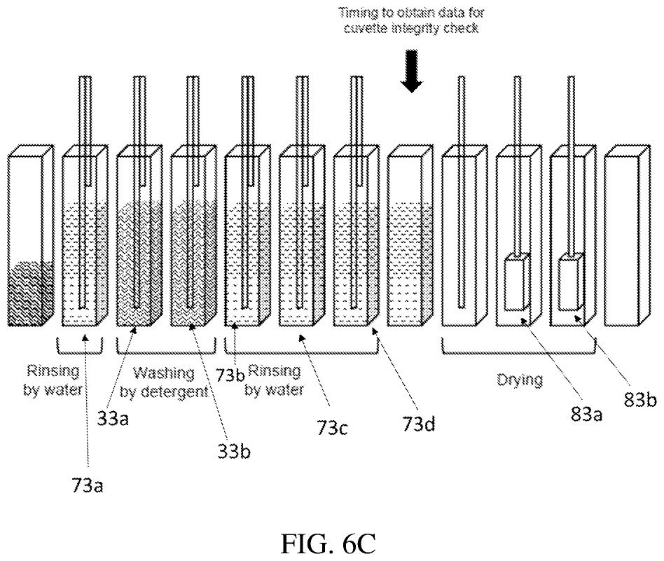

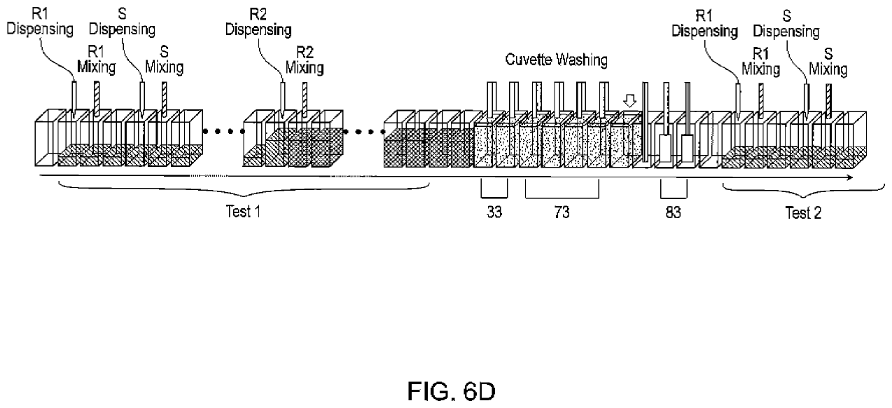

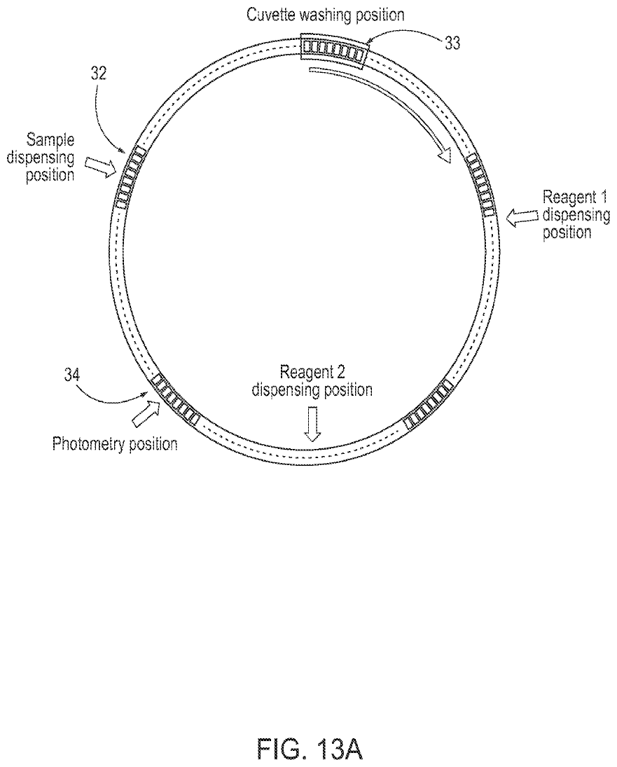

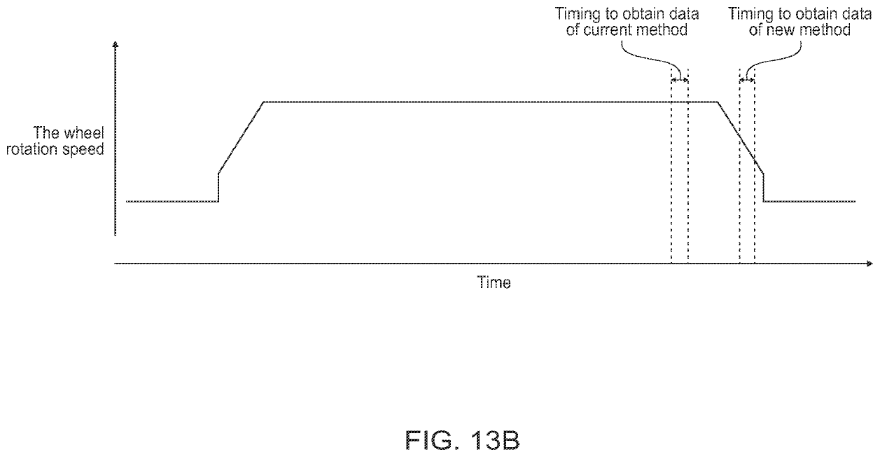

As described herein, an on-the-fly calibration and validation analysis can be performed that overcomes these disadvantages. In an on-the-fly analysis, the cuvettes are calibrated and validated during normal measurement cycles and not as a separate cycle. In one embodiment, an on-the-fly calibration and validation analysis is conducted in the measurement mode and in parallel with the measurement of biological samples. See FIG. 8. Also, instead of the sixteen (16) data points described above, a plurality of absorbance data points are obtained. In one embodiment, the fifty-six (56) data points are taken during the cuvette wash sequence. See FIGS. 6A-6D where the on-the-fly calibration and validation data is taken at the point indicated by the arrow. See also FIG. 13A.

The plurality of absorbance data points are gathered during cuvette rotation, whereby each absorbance data point is from a slightly different area of the cuvette. Table 1 illustrates a comparison of one embodiment of the disclosure (“Embodiment 1”) with the routine analysis (“Routine Test”). As shown, Embodiment 1, is able to generate forty additional data points when compared to the routine analysis.

TABLE 1
Photometry spec comparison

| Type of | # of data | Total scan | Rotation |
|---|---|---|---|
| measurement | points | duration | speed |
| Routine Test | 16 | 1.067 msec | Const. 1.43 |
| See FIG. 5 | | | mm/msec |
| Embodiment 1 | 56 | 3.733 msec | Ave. 0.50 |
| See FIG. 6A | | | mm/msec |

There are at least two reasons why the number of data points are different between Embodiment 1 and the Routine Test. In some embodiments, the increase in the number of absorbance data points measured may be related to a number of factors, including, but not limited to CPU speed and/or rotation speed.

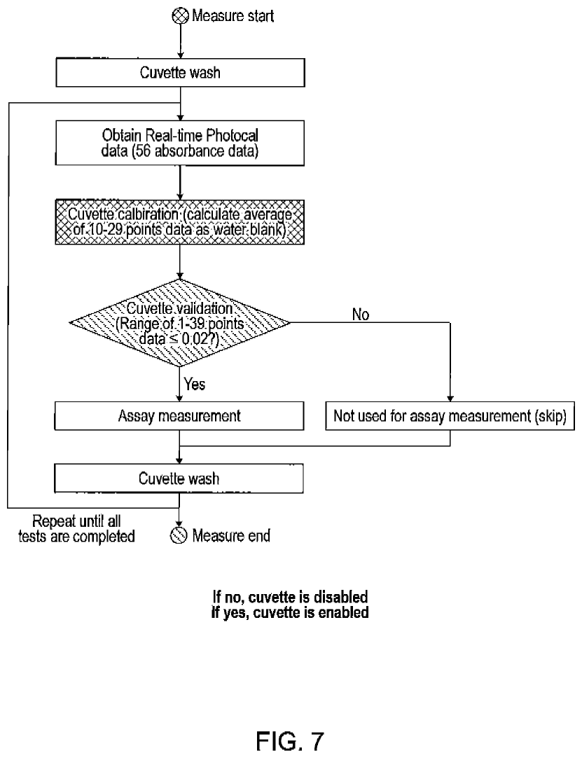

The resulting data points are categorized into three data groups. Rules should be determined for each system using actual data measured on each system to set logics for cuvette calibration and validation. This is depicted in flowchart form in FIG. 7, which illustrates the procedure for the determination of whether a cuvette is enabled or disabled.

A first data group is defined as unstable if an individual data point deviates more than a pre-determined threshold (across all wavelengths) from a grand wet or grand dry average. This first pre-determined threshold can be a deviation of ±0.0100 between the maximum and minimum of all thirteen wavelengths evaluated. If a cuvette falls into this first data group, i.e., deviation is higher than a first pre-determined threshold, the corresponding cuvette will be assigned a disabled status.

A second data group is defined as very stable if an individual data point deviates less than a pre-determined value (across all wavelengths) from a grand wet or grand dry average. This second pre-determined threshold can be a deviation of ±0.0050 between the maximum and minimum of all thirteen wavelengths evaluated. If a cuvette falls into this second data group, i.e., deviation is lower than a second pre-determined threshold, the corresponding cuvette will be assigned an enable status.

A third data group is defined as stable if an individual data point falls in between a minimum pre-determined value and maximum pre-determined value (across all wavelengths) from a grand wet or grand dry average. This pre-determined range can have a minimum pre-determined value with a deviation of ±0.0050 and a maximum pre-determined value with a deviation of ±0.0100 of all thirteen wavelengths evaluated. If a cuvette falls into this third data group, i.e., within a pre-determined range, the corresponding cuvette will be assigned an enable status.

In some embodiments, the controller 60 is configured to schedule the automated analyzer 10 to operate in a diagnostic mode or a measurement mode. See FIG. 8.

When the controller is scheduled to operate in a diagnostic mode, which includes, but is not limited to, scheduling one or more cuvettes 20 for dilution, pre-treatment, and/or other non-photometer-tested activity, a constituent may be dispensed into one or more cuvettes 20 when the corresponding cuvette is at the constituent dispensing position 32 when the cuvette is assigned an enabled status and when the cuvette is assigned a disabled status. In an embodiment, the constituent dispensed in the disabled cuvette can comprise a portion of a dilution or a portion of a pre-treatment.

A constituent includes, but is not limited to, Quality Controls (QCs), calibrators, pre-treatment fluids, diluents, de-ionized water, and biological samples. Exemplary biological samples include, but are not limited to, blood, plasma, serum, saliva, urine, cerebrospinal fluid, lacrimal fluid, perspiration, gastrointestinal fluid, amniotic fluid, mucosal fluid, pleural fluid, and sebaceous oil. In some embodiments, the biological sample is from a vertebrate. In some embodiments, the biological sample is from, for example, a mammal, preferably a human. In some embodiments, the biological sample is from, for example, a bird, a fish, a reptile, or an amphibian. In some embodiments, the constituent is subject to a constituent test. In a constituent test, a property of the constituent is measured, such as concentration.

In some embodiments, the constituent is test-ready. A test-ready constituent is a constituent that is ready to be dispensed into a corresponding cuvette at the constituent dispensing position and indicates that the constituent will be tested in the corresponding cuvette by the photometer when the constituent measurement position is reached by the corresponding cuvette and also indicates that the constituent dispensing position does not currently have an empty cycle or a dilution cycle (or another cycle that will not be measured by the photometer). In this embodiment, the constituent may be a biological sample.

An empty cycle indicates that the automated analyzer 10 is running at less than capacity and/or has some non-efficiency that prevents a ready-to-dispense status. Thus, the constituent dispensing position remains idle during an empty cycle. A dilution cycle indicates that the constituent dispensing position is planned to perform a dilution. In a dilution cycle, the constituent dispensed into the one or more cuvettes 20 is not subsequently measured at the constituent measurement position.

When the controller 60 is scheduled to operate in a measurement mode, which includes, but is not limited to, scheduling one or more cuvettes 20 for photometer activity (e.g., testing, calibrating, or Quality Control, among others), a constituent may be dispensed into one or more cuvettes 20 when the corresponding cuvette is at the constituent dispensing position 32 when the cuvette is assigned an enabled status. However, if the one or more cuvettes 20 is assigned a disabled status, no constituent will be dispensed into said cuvette. In this embodiment, when a corresponding cuvette contains a constituent, and a constituent test is scheduled for the corresponding cuvette, when the corresponding cuvette is at the constituent measurement position 34, the constituent in the corresponding cuvette will be measured with the photometer 50. In some embodiments, before the constituent in the corresponding cuvette is measured, the cuvette with the constituent is moved to the at least one reagent dispensing position 31 and a reagent is dispensed. In some embodiments, there is at least a first reagent dispensing position and a second reagent dispensing position. In some embodiments, two reagents are dispensed. In other embodiments, multiple reagents are dispensed. In some embodiments, the controller 60 can schedule when reagents should be dispensed.

In an embodiment, when the corresponding cuvette is assigned a disabled status, the constituent test for said corresponding cuvette is rescheduled. The rescheduling may occur in response to an earlier known disabled status, for example, a disabled status assigned when the automated analyzer 10 was in a diagnostic mode, or the rescheduling may occur in response to a just-assigned disabled status. The rescheduling may also result in the substitution of a non-tested constituent in the corresponding cuvette. This non-tested constituent may comprise, but is not limited to, a portion of a dilution or a portion of a pre-treatment.

In an embodiment, the automated analyzer 10 is configured to wash the cuvettes prior to assay measurement. As shown in FIGS. 6A-6D, washing has three phases: washing with detergent/cleaning solution 33; rinsing with water 73; and drying 83. In FIG. 6A, the cuvettes are washed with a detergent or other suitable cleaning solution at two sequential cuvette washing positions 33a, 33b, and rinsed with de-ionized water at four sequential cuvette rinsing positions 73a, 73b, 73c, 73d. Prior to aspirating the water from the cuvette, the cuvette integrity is checked, and then the cuvette is dried at two sequential cuvette drying positions 83a, 83b. In FIG. 6B, the cuvettes are rinsed with de-ionized water at a cuvette rinsing position 73a, washed with a detergent or other suitable cleaning solution at a cuvette washing positions 33a, and rinsed with de-ionized water at four sequential cuvette rinsing positions 73b, 73c, 73d, 73e. Prior to aspirating the water from the cuvette, the cuvette integrity is checked, and then the cuvette is dried at two sequential cuvette drying positions 83a, 83b. In FIG. 6C, the cuvettes are rinsed with de-ionized water at a cuvette rinsing position 73a, washed with a detergent or other suitable cleaning solution at two sequential cuvette washing positions 33a, 33b, and rinsed with de-ionized water at three sequential cuvette rinsing positions 73b, 73c, 73d. Prior to aspirating the water from the cuvette, the cuvette integrity is checked, and then the cuvette is dried at two sequential cuvette drying positions 83a, 83b. The detergent or other suitable cleaning solution may be a mild detergent or a concentrated solution. In some embodiments, the detergent may be highly concentrated. Suitable non-limiting examples of detergents or cleaning solutions include, but are not limited to, alkaline cleaning concentrates such as tripotassium orthophosphate and ethanol mixtures, among others.

In an embodiment, the automated analyzer 10 is configured to apply at least one enhanced cleaning routine when a cuvette assigned the disabled status is at the at least one cuvette washing position 33. In this embodiment, the at least one enhanced cleaning routine includes dispensing detergent or other suitable cleaning solution to the cuvette assigned the disabled status. After applying the enhanced cleaning routine, the cuvette assigned the disabled status is measured with the photometer when the cuvette is at the constituent measurement position 34. If the at least one characteristic measured for the corresponding cuvette is higher than a first pre-determined threshold, the corresponding cuvette is reassigned a disabled status. Alternatively, if the at least one characteristic measured for the corresponding cuvette is less than the second pre-determined threshold or within a pre-determined range, the corresponding cuvette is assigned an enabled status. If the corresponding cuvette is assigned an enable status, said cuvette may be used for any purpose (e.g., dilution, pre-treatment, other non-photometer-tested activity, and/or photometer activity, among others.) In an embodiment, the cuvette assigned or reassigned a disable status is not assigned an enable status unless the at least one characteristic measured for the cuvette is less than the second pre-determined threshold or within a pre-determined range after three subsequent measurements.

In some embodiments, when the cuvette is reassigned the disable status, a subsequent enhanced cleaning routine is applied when the cuvette with the reassigned disabled status is at the at least one cuvette washing position 33. During or prior to the enhanced cleaning routine, the cuvettes reassigned a disabled status are deemed temporarily disabled. This results in the temporarily disabled cuvettes being able to be used when the automated analyzer 10 is in diagnostic mode purposes (e.g., purposes related to dilution, pre-treatment, or other non-photometer-tested activity.) When the temporarily disabled cuvette is not assigned a diagnostic mode purpose, the temporarily disabled cuvette will continue to be cleaned using the enhanced cleaning routine described herein.

The automated analyzer 10 is configured to continue the enhanced cleaning routine for a pre-determined number of applications. In some embodiments, the pre-determined number of applications is at least ten (10) applications. In other embodiments, the pre-determined number of applications is at least five (5) applications. In other embodiments, the pre-determined number of applications is at least fifteen (15) applications. If the cuvette assigned or reassigned a disabled status fails to be reassigned an enabled status at the conclusion of the enhanced cleaning routine, the cuvette is assigned a retirement status. A cuvette assigned a retirement status may still be used when the automated analyzer 10 is in diagnostic mode for diagnostic mode purposes, however an operator receives a notification of the need to replace the retired cuvettes. The notification can be, for example, a system notification, a display screen notification, a push notification, a text notification, and/or an email notification.

In some embodiments, the operator receives a notification if at least a pre-determined number of the cuvettes are assigned a retirement status. In an embodiment, at least about 10% of the cuvettes are assigned a retirement status. In other embodiments, the notification is received when at least about 5% of the cuvettes are assigned a retirement status. In other embodiments, the notification is received when at least about 15% of the cuvettes are assigned a retirement status.

In some embodiments, the automated analyzer 10 is configured to notify an operator of a need to replace a cuvette assigned a disabled status. If at least a pre-determined number of the cuvettes are assigned a disable status, the operator is notified of the negative impact the disabled cuvettes may have on the throughput of the automated analyzer 10. This includes notifying the operator of the reduced capacity of the automated analyzer 10 due to the disabled status of at least one of the cuvettes and/or notifying the operator of a location on the cuvette transporter 40 of each of the cuvettes to be replaced via a display screen. In an embodiment, the pre-determined number can be at least about 20% of the total cuvettes. In alternative embodiments, the pre-determined number can be at least about 15% of the total cuvettes, alternatively at least about 25% of the total cuvettes.

Additional examples are provided below.

### Example 1: Cuvette Calibration and Cuvette Validation Logic

A trend of the raw absorbance data (56 absorbance data points for each cuvette and each wavelength) was analyzed for 179 cuvettes using a Conventional Chemistry Analyzer. The resulting data points were categorized into ‘very stable’, ‘stable’, and ‘unstable’.

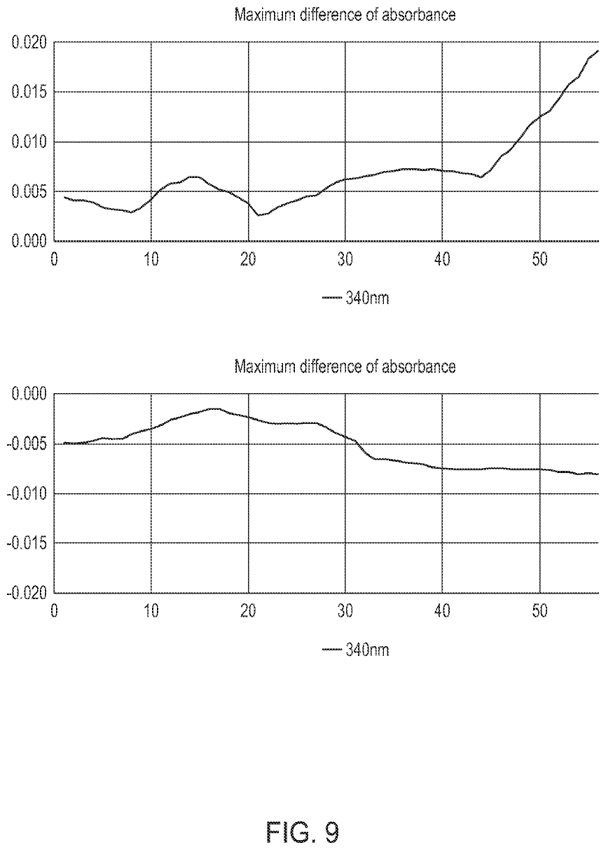

To compare results of all cuvettes, each cuvette absorbance data point was corrected with baseline absorbance, which is considered as a wet cell blank of the cuvette. FIG. 9 shows the maximum and minimum data for each of the 179 cuvettes for each point at 340 nm. When the maximum and minimum absorbance data points are close to 0, this means that absorbance data at the point is very close to the wet cell blank of the cuvette. When the variation between maximum and minimum absorbance data points is small, the outcome correlates to a small cuvette variability.

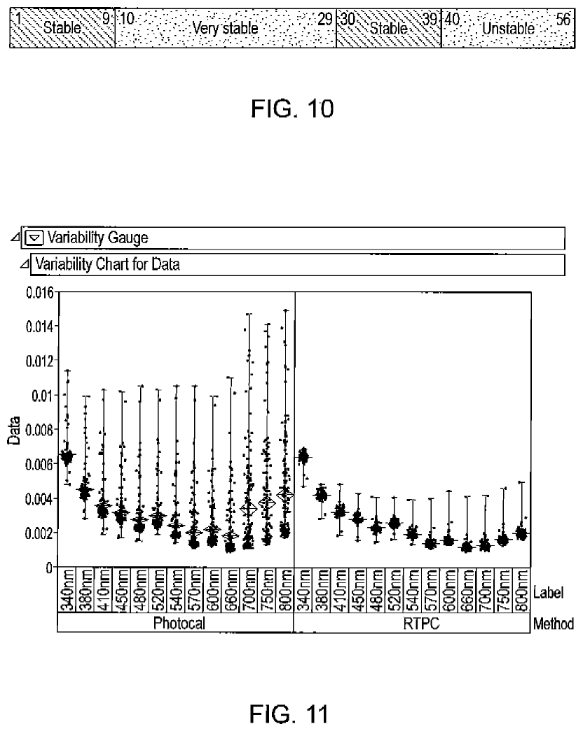

The fifty-six data points were categorized into three groups with the following rules (refer to FIG. 10 for results of data point groups).

(a) Unstable’ data point: At this data point, the difference between maximum and minimum is more than 0.0100 for all of 13 wavelengths. Data points from 40 to 56 were categorized into this group.

(b) ‘Very stable’ data point: At this data point, the difference between maximum and minimum is 0.0100 or less for all of 13 wavelengths. And minimum is −0.0035 or more for all of 13 wavelengths. Data points from 10 to 29 were categorized into this group.

© ‘Stable’ data point: Data points which are not categorized into ‘Unstable’ or ‘Very stable’ are categorized into ‘Stable’. Data points from 1 to 9 and from 30 to 39 were categorized into this group.

### Example 2: Results of Cuvette Calibration

FIG. 11 shows ranges of baseline absorbance measured by the routine method and the method of embodiment 1. Twenty-nine absorbance data points for each of the Routine Test method and the method of Embodiment 1 were measured on 179 cuvettes. The range of the twenty-nine absorbance data points measured by either method was calculated for each cuvette at each wavelength, and it was plotted as one dot in FIG. 11. The left half of FIG. 11 shows the Routine Test, and the right half shows the method of Embodiment 1. As FIG. 11 illustrates, the range of baseline absorbance measured by the method of Embodiment 1 tends to be less than what is measured by the Routine Test. As such, Embodiment 1 can measure additional stable data of baseline absorbance compared to the Routine Test.

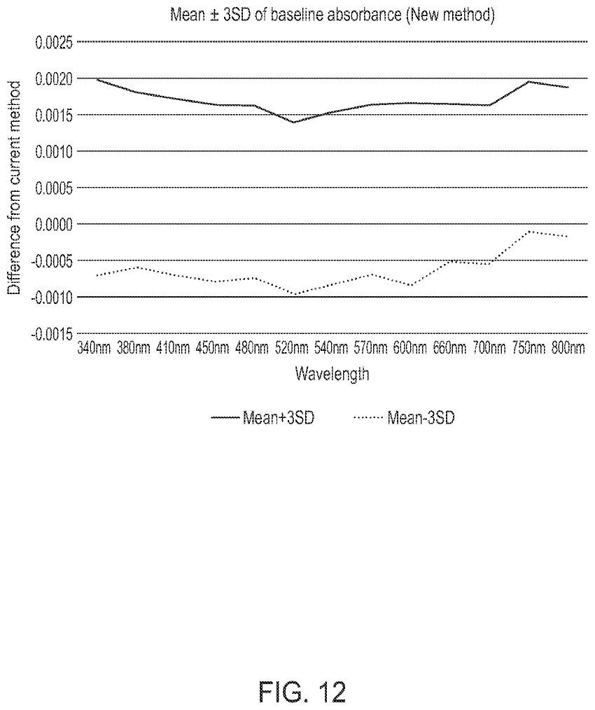

FIG. 12 shows the difference of baseline absorbances between Embodiment 1 and the Routine Test for each wavelength. FIG. 12 illustrates the mean+3SD and mean−3SD of 5191 data absorbance points, and mean±3SD are located within ±0.0020 for all of 13 wavelengths. As such, the baseline absorbance measured by Embodiment 1 was very close to the baseline absorbance measured by the Routine Test.

### Example 3: Results of Cuvette Validation with the Method of Embodiment 1

Table 2 shows the results of cuvette validation judged by the method of Embodiment 1. In the method, new cuvettes and dirty/scratched cuvettes were set up on a Conventional Chemistry Analyzer. The cuvettes were first validated using the routine method for ten separate analyses. The cuvettes were categorized into the following two groups with the rules as below.

Group 1: Cuvettes to be Judged as ‘Pass’

Cuvettes that were passed by the Routine Test for all of ten times were categorized into group 1 (to be judged as ‘Pass’). Two hundred thirty-one cuvettes (231) were categorized into this group.

Group 2: Cuvettes to be Judged as ‘Fail’

Cuvettes that were failed by the routine method for all of ten times were categorized into group 2 (to be judged as ‘Fail’). One hundred thirteen cuvettes (113) were categorized into this group.

Cuvettes that were not categorized into group 1 or 2 were excluded from this result, because it is unknown how those cuvettes should be judged.

Cuvettes categorized into group 1 or 2 were then validated for ten separate analyses using the method of Embodiment 1 with the logic described in Example 1. As illustrated in Table 2, all of two hundred thirty-one cuvettes (231) cuvettes categorized into group 1 were judged as ‘Pass’ for all ten times, and all of one hundred thirteen cuvettes (113) cuvettes categorized into group 2 were judged as ‘Fail’ for all ten times. This indicates that cuvettes can be validated by the method of Embodiment 1 instead of the Routine Test.

TABLE 2
Results of cuvette validation by the method of embodiment 1

| | Judgment by the method of Embodiment 1 | | |
|---|---|---|---|
| | Pass | Fail | Total |
| Group 1: To be | 2310 | 0 | 2310 |
| judged as ‘Pass’ | | | |
| Group 2: To be | 0 | 1130 | 1130 |
| judged as ‘Fail’ | | | |
| Total | 2310 | 1130 | 3440 |

### Example 4: Cuvette Position and Function Layout

FIG. 13A illustrates an exemplary cuvette position layout and each corresponding function for an on-the-fly calibration and validation process. In this example, the photometry position is fixed. Focusing on one cuvette, the cuvette is passing in front of the photometry position every five cycles. Because the wheel rotates forty-one (41) positions for one cycle, the total number of cuvettes is two hundred-four (204) in one line (inner or outer) (41 positions×5 cycles=204 (1 revolution)+1). The cycle has an acceleration portion, a constant velocity portion, a deceleration portion, and a rest portion. The on-the-fly tracking, which includes measuring absorbance data, occurs in the cycle's non-constant velocity portion. Thus, more time is available to collect the plurality of data points. In this example, fifty-six absorbance data points were collected. FIG. 13B illustrates a profile of a photometer in accordance with Example 4.

1. A method of operating an automated analyzer (10), the method comprising the steps of:
providing the automated analyzer (10), the automated analyzer (10) comprising:
a plurality of cuvettes;
a plurality of positions, the plurality of positions comprising:
at least one reagent dispensing position (31);
at least one constituent dispensing position (32);
at least one cuvette washing position (33); and
at least one constituent measurement position (34);
at least one cuvette transporter (40) having a plurality of cuvette holders (41);
at least one photometer (50); and
a controller (60);
moving the plurality of cuvettes between the plurality of positions with the at least one cuvette transporter (40) according to a schedule of the controller (60);
measuring one or more cuvettes (20) of the plurality of cuvettes with the at least one photometer (50) when each of the one or more cuvettes (20) is at the at least one constituent measurement position (34) according to the schedule of the controller (60) and thereby determining at least one characteristic of each of the one or more cuvettes (20);
assigning to each of the one or more cuvettes (20) measured at the at least one constituent measurement position (34) a disabled status if the at least one characteristic of the cuvette is higher than a first pre-determined threshold; and
dispensing a constituent into a corresponding cuvette of the plurality of cuvettes when the corresponding cuvette is at one of the dispensing positions if a constituent test is scheduled for the corresponding cuvette at the at least one constituent measurement position (34) according to the schedule of the controller (60), unless the corresponding cuvette is assigned the disabled status.

2. The method of claim 1, further comprising the step of measuring the constituent in the corresponding cuvette with the at least one photometer (50) when the corresponding cuvette is at the at least one constituent measurement position (34) if the constituent was dispensed into the corresponding cuvette, and if the constituent test was scheduled for the corresponding cuvette at the at least one constituent measurement position (34).

3. The method of claim 1, further comprising the step of re-scheduling the constituent test if the corresponding cuvette is assigned the disabled status.

4. The method of claim 3, wherein the rescheduling occurs in response to an earlier known disabled status.

5. The method of claim 3, wherein the rescheduling occurs in response to a just-assigned disabled status.

6. The method of any of claims 3-5, wherein the rescheduling results in a substitution of a non-tested constituent.

7. The method of 6, wherein the non-tested constituent comprises a portion of a dilution.

8. The method of 6, wherein the non-tested constituent comprises a portion of a pre-treatment.

9. The method of any of the preceding claims, wherein the constituent is a biological sample.

10. The method of claim 9, wherein the biological sample is selected from the group consisting of blood, plasma, serum, saliva, urine, cerebrospinal fluid, lacrimal fluid, perspiration, gastrointestinal fluid, amniotic fluid, mucosal fluid, pleural fluid, and sebaceous oil.

11. The method of claim 9 or claim 10, wherein the biological sample is from a mammal, preferably a human.

12. The method of any one of claims 9-11, wherein the biological sample is test-ready.

13. The method of any one of claims 9-12, wherein before the constituent is measured with the at least one photometer (50), the corresponding cuvette is moved to the at least one reagent dispensing position (31) and a reagent is dispensed.

14. The method of any of the preceding claims, wherein the measuring of the one or more cuvettes (20) of the plurality of cuvettes with the at least one photometer (50) includes measuring absorbance for each of the cuvettes for at least one pre-determined wavelength of electromagnetic radiation.

15. The method of claim 14, wherein measuring absorbance for each of the cuvettes for the at least one pre-determined wavelength of electromagnetic radiation generates a plurality of absorbance data points for each of the cuvettes at each of the at least one pre-determined wavelength of electromagnetic radiation.

16. The method of claim 14 or claim 15, wherein the absorbance for each of the cuvettes is measured for at least two pre-determined wavelengths of electromagnetic radiation, alternatively for at least three pre-determined wavelengths of electromagnetic radiation, alternatively for at least four pre-determined wavelengths of electromagnetic radiation, alternatively for at least five pre-determined wavelengths of electromagnetic radiation, alternatively for at least six pre-determined wavelengths of electromagnetic radiation, alternatively for at least seven pre-determined wavelengths of electromagnetic radiation, alternatively for at least eight pre-determined wavelengths of electromagnetic radiation, alternatively for at least nine pre-determined wavelengths of electromagnetic radiation, alternatively for at least ten pre-determined wavelengths of electromagnetic radiation, alternatively for at least eleven pre-determined wavelengths of electromagnetic radiation, alternatively for at least twelve pre-determined wavelengths of electromagnetic radiation.

17. The method of any one of the preceding claims wherein the measuring of the one or more cuvettes (20) of the plurality of cuvettes with the photometer (50) includes measuring absorbance for each of the cuvettes at thirteen different pre-determined wavelengths of electromagnetic radiation.

18. The method of claim 17, wherein the thirteen different pre-determined wavelengths of electromagnetic radiation comprise a short wavelength limit, a long wavelength limit, and eleven different wavelengths between the short wavelength limit and the long wavelength limit.

19. The method of any one of claims 14-18, wherein at least one of the pre-determined wavelengths of electromagnetic radiation is a UV wavelength or a visible wavelength.

20. The method of claim 19, wherein the short wavelength limit is a UV wavelength, and the long wavelength limit is a visible wavelength.

21. The method of any one of claims 14-20, wherein the at least one characteristic of each of the one or more cuvettes (20) includes absorbance variance.

22. The method of claim 21, wherein the absorbance variance is a difference between a maximum absorbance and a minimum absorbance measured for at least one pre-determined wavelength of electromagnetic radiation.

23. The method of any of the preceding claims, further comprising assigning to each of the corresponding cuvettes measured at the constituent measurement position (34) an enabled status if the at least one characteristic of the corresponding cuvette is within a pre-determined range or less than a second pre-determined threshold.

24. The method of any of the preceding claims, further comprising applying at least one enhanced cleaning routine to a corresponding cuvette assigned the disabled status, when the corresponding cuvette is at the at least one cuvette washing position (33).

25. The method of claim 24, wherein the at least one enhanced cleaning routine includes dispensing detergent to the corresponding cuvette assigned the disabled status.

26. The method of claim 24 or claim 25, wherein after applying the at least one enhanced cleaning routine, the method comprises further measuring the corresponding cuvette assigned the disabled status with the at least one photometer (50), when the corresponding cuvette is at the constituent measurement position (34) and reassigning a disabled status if the at least one characteristic of the corresponding cuvette is higher than the first pre-determined threshold or assigning an enabled status if the at least one characteristic of the corresponding cuvette is less than the second pre-determined threshold or within a pre-determined range.

27. The method of claim 26, wherein if the corresponding cuvette is reassigned the disabled status, a subsequent enhanced cleaning routine is applied when the corresponding cuvette with the reassigned disabled status is at the at least one cuvette washing position (33).

28. The method of claim 27, wherein the subsequent enhanced cleaning routine is applied for a pre-determined number of applications before the cuvette is assigned a retirement status.

29. The method of claim 28, wherein the pre-determined number of applications is at least ten applications.

30. The method of any of the preceding claims, further comprising notifying an operator of a need to replace at least one corresponding cuvette assigned the disabled status.

31. The method of claim 30, further comprising notifying the operator of the quantity of corresponding cuvettes assigned the disabled status.

32. The method of claim 30 or claim 31, further comprising notifying the operator of the reduced capacity of the automated analyzer (10) due to the disabled status of at least one of the corresponding cuvettes.

33. The method of any one of claims 30-32, further comprising notifying the operator of a location on the cuvette transporter (40) of each of the corresponding cuvettes to be replaced via a display screen.

34. The method of any of the preceding claims, wherein the automated analyzer (10) is an automated clinical chemistry analyzer.

35. The method of any of the preceding claims, wherein the plurality of cuvettes includes reusable cuvettes or disposable cuvettes.

36. The method of any of the preceding claims, wherein the plurality of cuvettes comprise glass, plastic, or optical-grade quartz.

37. The method of any of the preceding claims, wherein the at least one photometer (50) includes a light source (51).

38. The method of claim 37, further comprising monitoring a deterioration of the light source (51).

39. The method of claim 38, further comprising modeling the deterioration of the light source (51) with statistical analysis to forecast a replacement time.

40. The method of any one of claims 37-39, wherein the light source (51) is a halogen lamp.

41. The method of any of the preceding claims, wherein the one or more cuvettes (20) of the plurality of cuvettes contain a liquid when the at least one characteristic of the cuvette is determined.

42. The method of any one of claims claim 1-40, wherein the one or more cuvettes (20) of the plurality of cuvettes do not contain liquid when the at least one characteristic of the cuvette is determined.

43. The method of claim 42, further comprising performing statistical analysis on the at least one characteristic of the cuvette.

44. The method of claim 43, wherein the statistical analysis produces values distinguishing an imperfection type.

45. The method of claim 44, wherein the imperfection type comprises scratches and stains.

46. The method of claim 42, wherein after determining the at least one characteristic of at least one cuvette that does not contain liquid, said cuvette is then filled with a liquid, and at least one characteristic of said cuvette filled with a liquid is determined.

47. The method of claim 41 or claim 46, wherein the liquid is de-ionized water.

48. The method of any of the preceding claims, wherein the cuvette transporter (40) includes a wheel (42) with the plurality of cuvette holders (41).

49. The method of claim 48, wherein the cuvette transporter (40) moves the plurality of cuvettes between the plurality of positions at a fixed sequence.

50. A method of operating an automated analyzer (10), the method comprising the steps of:
providing the automated analyzer (10), the automated analyzer (10) comprising:
a plurality of cuvettes;
a plurality of positions, the plurality of positions comprising:
at least one reagent dispensing position (31);
at least one constituent dispensing position (32);
at least one cuvette washing position (33); and
at least one constituent measurement position (34);
at least one cuvette transporter (40) having a plurality of cuvette holders (41);
at least one photometer (50); and
a controller (60);
moving the plurality of cuvettes between the plurality of positions with the at least one cuvette transporter (40) according to a schedule of the controller (60);
measuring absorbance for each of the one or more cuvettes (20) of the plurality of cuvettes for at least one pre-determined wavelength of electromagnetic radiation with the at least one photometer (50) when each of the one or more cuvettes (20) is at the at least one constituent measurement position (34) according to the schedule of the controller (60) and thereby determining at least the absorbance variance of each of the one or more cuvettes (20);
assigning to each of the one or more cuvettes (20) measured at the at least one constituent measurement position (34) a disabled status if the absorbance variance of the cuvette is higher than a first pre-determined threshold;
dispensing a constituent into a corresponding cuvette of the plurality of cuvettes when the corresponding cuvette is at one of the dispensing positions if a constituent test is scheduled for the corresponding cuvette at the at least one constituent measurement position (34) according to the schedule of the controller (60), unless the corresponding cuvette is assigned the disabled status;
measuring the constituent in the corresponding cuvette with the at least one photometer (50) when the corresponding cuvette is at the at least one constituent measurement position (34) if the constituent was dispensed into the corresponding cuvette, and if the constituent test was scheduled for the corresponding cuvette at the at least one constituent measurement position (34); and
re-scheduling the constituent test if the corresponding cuvette is assigned the disabled status.

51. A method of operating an automated analyzer (10), the method comprising the steps of:
providing the automated analyzer (10), the automated analyzer (10) comprising:
a plurality of cuvettes;
a plurality of positions, the plurality of positions comprising:
at least one reagent dispensing position (31);
at least one constituent dispensing position (32);
at least one cuvette washing position (33); and
at least one constituent measurement position (34);
at least one cuvette transporter (40) having a plurality of cuvette holders (41);
at least one photometer (50); and
a controller (60);
moving the plurality of cuvettes between the plurality of positions with the at least one cuvette transporter (40) according to a schedule of the controller (60);
measuring one or more cuvettes (20) of the plurality of cuvettes with the at least one photometer (50) when each of the one or more cuvettes (20) is at the at least one constituent measurement position (34) according to the schedule of the controller (60) and thereby determining at least one characteristic of each of the one or more cuvettes (20);
assigning to each of the one or more cuvettes (20) measured at the at least one constituent measurement position (34) a disabled status if the at least one characteristic of the cuvette is higher than a first pre-determined threshold;
dispensing a constituent into a corresponding cuvette of the plurality of cuvettes when the corresponding cuvette is at one of the dispensing positions if a constituent test is scheduled for the corresponding cuvette at the at least one constituent measurement position (34) according to the schedule of the controller (60), unless the corresponding cuvette is assigned the disabled status;
applying at least one enhanced cleaning routine to a corresponding cuvette assigned the disabled status, when the corresponding cuvette is at the at least one cuvette washing position (33) and further measuring the corresponding cuvette assigned the disabled status with the at least one photometer (50), when the corresponding cuvette is at the constituent measurement position (34) and reassigning a disabled status if the at least one characteristic of the corresponding cuvette is higher than the first pre-determined threshold or assigning an enabled status if the at least one characteristic of the corresponding cuvette is less than the second pre-determined threshold or within a pre-determined range.

52. A method of operating an automated analyzer (10), the method comprising the steps of:
providing the automated analyzer (10), the automated analyzer (10) comprising:
a plurality of cuvettes;
a plurality of positions, the plurality of positions comprising:
at least one reagent dispensing position (31);
at least one constituent dispensing position (32);
at least one cuvette washing position (33); and
at least one constituent measurement position (34);
at least one cuvette transporter (40) having a plurality of cuvette holders (41);
at least one photometer (50); and
a controller (60);
moving the plurality of cuvettes between the plurality of positions with the at least one cuvette transporter (40) according to a schedule of the controller (60);
dispensing a liquid into one or more cuvettes (20) of the plurality of cuvettes when the one or more cuvettes is at the at least one cuvette washing position (33);
measuring the one or more cuvettes (20) of the plurality of cuvettes with the at least one photometer (50) when each of the one or more cuvettes (20) is at the at least one constituent measurement position (34) according to the schedule of the controller (60) and thereby determining at least one characteristic of each of the one or more cuvettes (20);
assigning to each of the one or more cuvettes (20) measured at the at least one constituent measurement position (34) a disabled status if the at least one characteristic of the cuvette is higher than a first pre-determined threshold;
washing the one or more cuvettes (20) of the plurality of cuvettes when the one or more cuvettes is at the at least one cuvette washing position (33); and
dispensing a constituent into a corresponding cuvette of the plurality of cuvettes when the corresponding cuvette is at one of the dispensing positions if a constituent test is scheduled for the corresponding cuvette at the at least one constituent measurement position (34) according to the schedule of the controller (60), unless the corresponding cuvette is assigned the disabled status.
